(19) United States
(12) Patent Application Publication
(10) Pub. No.: US 2001/0003911 A1
(43) Pub. Date: Jun. 21, 2001

(54) Optical fiber making method and optical fiber making apparatus

(75) Inventors: Kaoru Okuno, Yokohama-shi (JP); Katsuya Nagayama, Yokohama-shi (JP); Kazuya Kuwahara, Yokohama-shi (JP); Ichiro Tsuchiya, Yokohama-shi (JP)

Correspondence Address: MCDERMOTT WILL & EMERY, 600 13TH STREET, N.W., WASHINGTON, DC, 20005-3096, US

(73) Assignee: Sumitomo Electric Industries, Ltd.

(21) Appl. No.: 09/734,205

(22) Filed: Dec. 12, 2000

(30) Foreign Application Priority Data
Dec. 13, 1999 (JP) P1999-353258

(51) Int. Cl. C03B 37/023

(52) U.S. Cl. 65/435

(57) ABSTRACT

An optical fiber making apparatus has a main pipe connected to the furnace core tube, two branch pipes branching from the main pipe, and a gas source, a valve and a flow meter connected to each of the branch pipes. The flows or compositions of the inert gases supplied from the gas sources into the furnace core tube are varied. This changes the amount of heat applied to the lower end of the optical fiber preform, without depending solely on the main heater, to adjust the draw tension and thereby change the local chromatic dispersion along the longitudinal direction of the optical fiber being manufactured.

### BACKGROUND OF THE INVENTION

1. Field of the Invention

The present invention relates to a method and apparatus for making optical fibers by drawing an optical fiber from a preform and more particularly to an optical fiber making method and apparatus suited for making an optical fiber whose local chromatic dispersion is varied along its longitudinal direction.

2. Related Background Art

Several types of optical fibers are known which have their local chromatic dispersions at a particular wavelength varied along a longitudinal direction. For example, an optical fiber, whose chromatic dispersion at a particular wavelength is altered such that positive dispersion sections where the local chromatic dispersion is positive and negative dispersion sections where the local chromatic dispersion is negative are alternated along the longitudinal direction, is said to be able to suppress waveform deterioration caused by nonlinear optical phenomena and overall chromatic dispersions. It is therefore suitably used for optical transmission lines of a WDM (wavelength division multiplexing) transmission system (for example, see JP 8-320419A). An optical fiber whose local chromatic dispersion for a particular wavelength is monotonously changed along the longitudinal direction is said to be suited for soliton pulse compression that efficiently compresses signal optical pulses used in soliton communications (for example, refer to JP 10-167750A).

Fabricating an optical fiber from an optical fiber preform generally involves heating a furnace core tube in a drawing furnace with a main heater to melt the lower end of the preform within the furnace core tube and drawing a fiber from the molten lower end of the preform. In making such an optical fiber as is dispersion-altered or for soliton communications, a special process is provided which changes the local chromatic dispersion along the longitudinal direction.

For example, the aforementioned JP 8-320419A discloses an optical fiber making technique which involves the steps of preparing an optical fiber preform that changes in core diameter or preform diameter along its length, and drawing an optical fiber from the preform changing core diameter along the longitudinal direction while keeping fiber diameter constant; thereby making the optical fiber whose local chromatic dispersion is changed along the longitudinal direction. Another optical fiber making technique involves preparing an optical fiber preform having uniform refractive index profile and diameter along the longitudinal direction and changing the fiber diameter and the core diameter during the drawing process, or changing the draw tension to change the refractive index according to varying residual stresses, thereby changing the local chromatic dispersion along the longitudinal direction.

Further, JP 10-167750A discloses another optical fiber making technique which changes a drawing furnace temperature or a drawing speed during the drawing process to change the draw tension along the longitudinal direction and thereby change the local chromatic dispersion along the longitudinal direction. Further, JP 10-139463A discloses another optical fiber making technique which changes the draw tension along the longitudinal direction.

### SUMMARY OF THE INVENTION

The conventional optical fiber making techniques described above have the following problems. That is, drawing a preform, which has its core diameter or preform diameter change along the longitudinal direction, into an optical fiber with a constant fiber diameter requires a complex process of preparing the preform itself and therefore raises the making cost. With the technique that changes the fiber diameter, because the optical fiber manufactured by this technique has a varying fiber diameter along its length, connecting or splicing the optical fiber to another optical fiber is not easy, and splice loss may increase.

On the other hand, the technique that changes the draw tension, though it is not troubled with the above problems, has the following problems. That is, when it is attempted to change the temperature of the drawing furnace with the heater so as to change the draw tension along the longitudinal direction as disclosed in the JP 10-167750A, because the heat capacity of the drawing furnace is large, the temperature of the lower end of the optical fiber preform in the furnace core tube cannot be changed in a short time. This means that the dispersion-altered optical fiber fabricated with this technique will have an elongated transient sections between the positive dispersion section and the negative dispersion section. Since the transient sections have a small absolute value of the local chromatic dispersion, the ability to suppress the waveform deterioration due to nonlinear optical phenomena cannot be realized satisfactorily. When the drawing speed is changed so as to change the draw tension along the longitudinal direction as disclosed in JP 10-167750A, it is difficult to keep the fiber diameter of the optical fiber being manufactured constant unless the drawing speed is changed over a very long period of time. This in turn increases the transient sections. The JP 10-139463A does not disclose a concrete means for changing the draw tension along the longitudinal direction of an optical fiber.

The present invention has been accomplished to eliminate the above-described problems and provide an optical fiber making method and an optical fiber making apparatus that can easily manufacture, with an excellent controllability, an optical fiber whose local chromatic dispersion at a particular wavelength changes along the longitudinal direction.

According to an aspect of the invention, the optical fiber making method comprises the steps of: inserting an optical fiber preform into a furnace core tube of a draw furnace; heating the furnace core tube with a main heater to heat and melt a lower end portion of the optical fiber preform; and drawing an optical fiber from the lower end of the optical fiber preform; wherein, while drawing the optical fiber, an amount of heat applied to the lower end portion of the optical fiber preform is changed, without depending solely on the main heater, so as to change a draw tension and thereby change a local chromatic dispersion along a longitudinal direction of the optical fiber being manufactured.

With this optical fiber making method, the temperature of the lower end portion of the optical fiber preform in the furnace core tube can be changed in a short time by changing the amount of heat applied to the lower end portion of the optical fiber preform without depending solely on the main heater. Hence, when the optical fiber to be manufactured is a dispersion-altered optical fiber, for example, the transient section between the positive dispersion section and the negative dispersion section can be reduced, realizing a satisfactory capability of suppressing waveform deterioration due to nonlinear optical phenomena.

Among possible methods for changing the amount of heat applied to the lower end portion of the optical fiber preform are (1) a method that supplies a gas to the periphery of the lower end portion of the optical fiber preform to change at least one of gas flow rate and gas composition, (2) a method that changes amount of heat supplied from the auxiliary heater provided close to the lower end portion of the optical fiber preform, (3) a method that change the heat insulating or dissipating condition from the furnace core tube or the lower end portion of the optical fiber preform, and (4) a method that changes the positional relation between the optical fiber preform and the furnace core tube. These methods can advantageously change the amount of heat applied to the lower end portion of the optical fiber preform without depending solely on the main heater.

It is preferred to measure the draw tension and adjust the amount of heat applied to the lower end portion of the optical fiber preform so that the measured draw tension becomes a predetermined value. In this case, to produce a desired draw tension, it is possible to finely adjust the flow or composition of the gas supplied, the heating condition of the auxiliary heater, the insulating/dissipating condition of heat supplied to the lower end portion, or the positional relation between the optical fiber preform and the furnace core tube.

According to another aspect of the invention, there is provided an optical fiber making apparatus which can advantageously implement the above-mentioned optical fiber making method and which comprises: a draw furnace having a furnace core tube into which an optical fiber preform is inserted and a main heater to heat the furnace core tube, the draw furnace heating and melting a lower end portion of the optical fiber preform; a feeder to feed the optical fiber preform into the furnace core tube; a draw means to draw an optical fiber from the lower end of the optical fiber preform; and a draw tension adjust means to adjust a draw tension by adjusting the amount of heat applied to the lower end portion of the optical fiber preform.

This draw tension adjust means can be realized as by (1) a gas supply means which can supply a gas to the periphery of the lower end portion of the optical fiber preform and change either or both of the flow or composition of the gas, (2) an auxiliary heater disposed close to the lower end portion of the optical fiber preform and capable of controlling the amount of heat independently of the main heater, and (3) an insulating means provided close to the lower end portion of the optical fiber preform to control heat dissipated from the furnace core tube or the lower end portion, and an insulating means varying device to change the position or state of the insulating means. Either of these draw tension adjust means can change the amount of heat applied to the lower end portion of the optical fiber preform to change in a short time the temperature of the lower end of the optical fiber preform in the furnace core tube. Hence, when the optical fiber to be manufactured is a dispersion-altered optical fiber, the transient section between the positive dispersion section and the negative dispersion section can be shortened, realizing a satisfactory capability of suppressing waveform deterioration due to nonlinear optical phenomena.

It is preferred that a tension measuring means for measuring the draw tension should be provided and that the draw tension adjust means control the amount of heat applied to the lower end of the optical fiber preform so that the draw tension measured by the tension measuring means is a predetermined value. In this case, to produce a desired draw tension based on the draw tension measured by the tension measuring means, a control means finely adjusts the flow or composition of the supplied gas, the heating condition of the auxiliary heater, and the dissipating condition of the dissipating means.

The present invention will be more fully understood from the detailed description given hereinbelow and the accompanying drawings, which are given byway of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is an explanatory diagram showing one example of an optical fiber manufactured by the optical fiber making method and the optical fiber making apparatus according to one embodiment of the invention.

FIG. 2 is an explanatory diagram showing one example of a refractive index profile of an optical fiber.

FIG. 3 is a schematic diagram showing an outline construction of the optical fiber making apparatus according to the invention.

FIG. 4 is an explanatory diagram showing an essential portion of the optical fiber making apparatus common to a first and a fourth embodiment.

FIG. 5 is an explanatory diagram showing an essential portion of the optical fiber making apparatus according to a second embodiment.

FIG. 6 is an explanatory diagram showing an essential portion of the optical fiber making apparatus according to a variation of the second embodiment.

FIG. 7 is an explanatory diagram showing an essential portion of the optical fiber making apparatus according to a third embodiment.

FIG. 8 is an explanatory diagram showing an essential portion of the optical fiber making apparatus according to a variation of the third embodiment.

### DESCRIPTION OF THE PREFERRED EMBODIMENTS

Embodiments of the present invention will be described in detail by referring to the accompanying drawings. To facilitate the comprehension of the explanation, the same reference numerals denote the same parts, where possible, throughout the drawings, and a repeated explanation will be omitted.

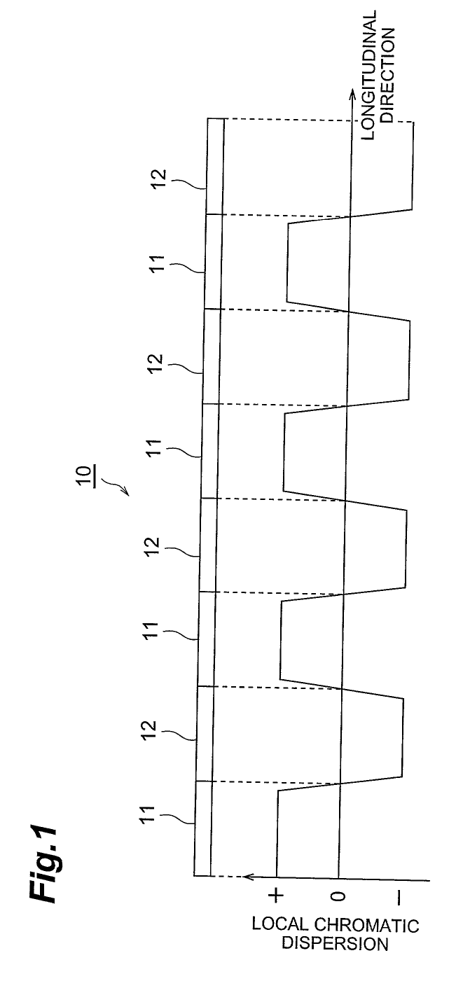

First, one example of an optical fiber made by the optical fiber making method or apparatus according to one embodiment of the present invention will be described by referring to FIG. 1. An optical fiber 10 shown in this diagram is dispersion-altered at a particular wavelength (for example, wavelength 1.55 μm) such that positive dispersion sections 11 where the local chromatic dispersion is positive and negative dispersion sections 12 where the local chromatic dispersion is negative are alternated along the longitudinal direction. Then, the optical fiber 10 can suppress waveform deterioration due to nonlinear optical phenomena by increasing an absolute value of local chromatic dispersion (for example, to more than 1 ps/nm/km) in almost all areas. This optical fiber 10 can also suppress waveform deterioration due to overall chromatic dispersion by reducing an average chromatic dispersion over the entire length. Therefore, this optical fiber 10 can suitably be used for optical transmission lines of a WDM transmission system. The optical fiber 10 is almost constant in fiber diameter and core diameter along the longitudinal direction. In this embodiment, the local chromatic dispersion of the optical fiber 10 is varied along the longitudinal direction by changing the amount of heat applied to the lower end of the molten preform to change the draw tension when the optical fiber 10 is drawn from the preform.

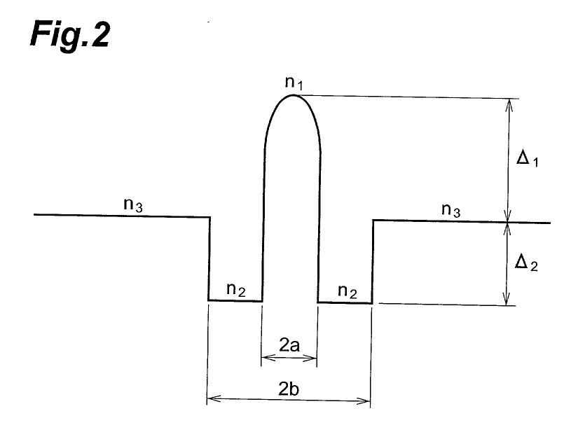

FIG. 2 is an explanatory diagram showing an example of refractive index profile of the optical fiber 10. The optical fiber 10 has a core area with a maximum refractive index of n₁ and an outer diameter of 2a, a depressed area with a refractive index of n₂ and an outer diameter of 2b, and a cladding area with a refractive index of n₃. These refractive indices have the relation of n₁>n₃>n₂. Such a refractive index profile can be realized, for example, by using a quartz glass as a base material, adding GeO₂ in the core area and adding F element in the depressed area. With the refractive index of the cladding area taken as a reference, a relative index difference in the core area Δ₁ (=n₁−n₃) is 0.9% and a relative index difference in the depressed area Δ₂ (=n₂−n₃) is −0.45%. The ratio of the outer diameter of the core area to that of the depressed area (2a/2b) is 0.58, and the outer diameter of the depressed area 2b is 11 μm.

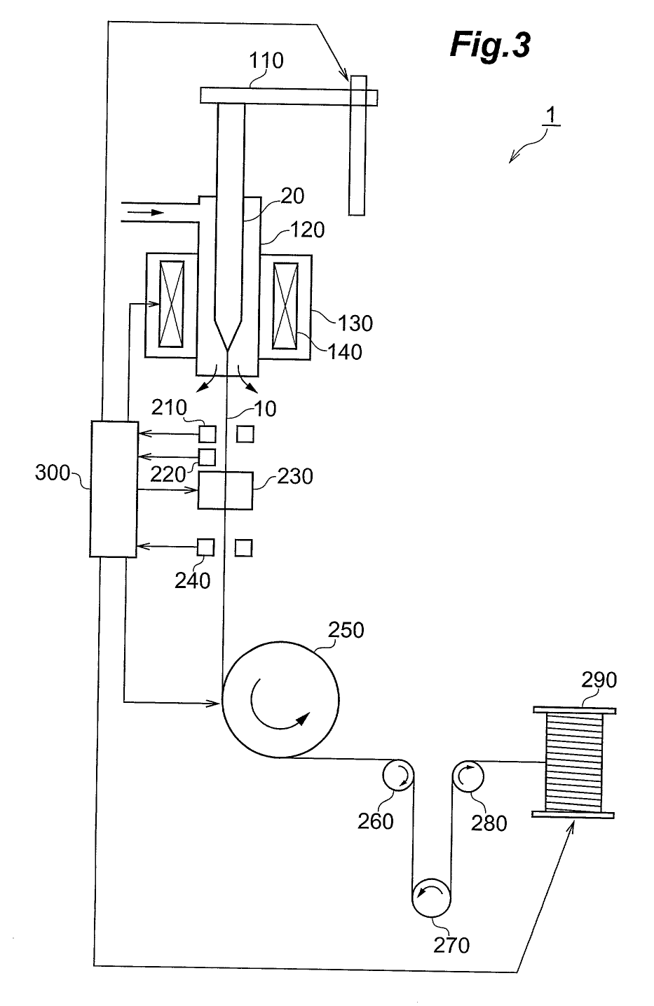

Next, an outline of the optical fiber making method and the optical fiber making apparatus will be explained by referring to FIG. 3. The features of the optical fiber making method and apparatus according to this embodiment will be described later.

In this optical fiber making apparatus 1, a preform 20 of optical fiber is mounted to a feeder 110 and set in a furnace core tube 120. An inert gas (N₂, He, Ar, etc.) is supplied into the interior of the furnace core tube 120. At the same time, a main heater 140 heats the furnace core tube 120 to melt the lower end of the preform 20 into a narrowed neck portion, with an optical fiber 10 drawn from the lower end of the molten preform 20.

The optical fiber 10 drawn out of the furnace core tube 120 is monitored for its glass diameter by an outer diameter measuring device 210 and is forcibly cooled by a forcibly cooling means (not shown). The result of measurement by the outer diameter measuring device 210 is reported to a draw controller 300, which in turn controls the draw conditions so as to make the glass diameter of the optical fiber 10 a predetermined value (normally 125 μm) The optical fiber 10, after passing through the outer diameter measuring device 210, is now measured for glass draw tension, without contact, by a tension measuring device 220. The result of measurement by the tension measuring device 220 is reported to the draw controller 300, which in turn controls the draw conditions so as to make the tension of the optical fiber 10 a predetermined value.

The optical fiber 10, after passing through the tension measuring device 220, is coated by a coating unit 230 with an ultraviolet curing resin which is then hardened by the radiation of ultraviolet ray, and thereby the fiber is coated with a primary coating layer. The diameter of the optical fiber 10 coated by the coating unit 230 is measured by an outer diameter measuring device 240. Then, the optical fiber 10 is passed through along a capstan 250, a roller 260, a dancer roller 270 and a roller 280 in that order and wound up by a bobbin 290.

The draw controller 300, based on the glass diameter of the optical fiber 10 measured by the outer diameter measuring device 210 and the glass draw tension of the optical fiber 10 measured by the tension measuring device 220, controls the rotation of the capstan 250 to adjust the draw speed, controls the rotation of the bobbin 290 so that the position of the dancer roller 270 remains unchanged, controls the feed speed of the feeder 110 which inserts the preform 20 into the furnace core tube 120 so as to control the line speed and tension, and controls the main heater 140 at a particular temperature to heat the furnace core tube 120. Further, in this embodiment, the draw controller 300 also controls an auxiliary heater 161 or the kind and flow of gas to be supplied into the furnace core tube 120.

A feature of this embodiment is that, in the manufacture of the optical fiber 10 by the above optical fiber making method or apparatus, the amount of heat applied to the lower end (narrowed neck portion) of the preform 20 in the furnace core tube 120 is changed, without depending solely on the main heater 140, to adjust the draw tension and thereby change the local chromatic dispersion of the optical fiber 10 along its longitudinal direction. There is no need to change the heated state of the furnace core tube 120 by the main heater 140.

Changing the amount of heat received by the lower end of the preform 20 without depending solely on the main heater 140 can change the temperature of the lower end of the preform 20 in a short time. Hence, the transient sections between the positive dispersion sections 11 and the negative dispersion sections 12 in the dispersion-altered optical fiber 10 are shortened, realizing a satisfactory capability of suppressing waveform deterioration due to nonlinear optical phenomena.

In the following description we will explain, as the first to fourth embodiment, various means for changing the amount of heat received by the lower end of the preform 20 in the furnace core tube 120, without depending solely on the main heater 140. In either of the following embodiments, it is assumed that the dispersion-altered optical fiber 10 described by referring to FIG. 1 and FIG. 2 is manufactured and that the positive dispersion section 11 and the negative dispersion section 12 each has a length of about 2 km and the glass diameter of the optical fiber 10 is 125 μm.

### (First Embodiment)

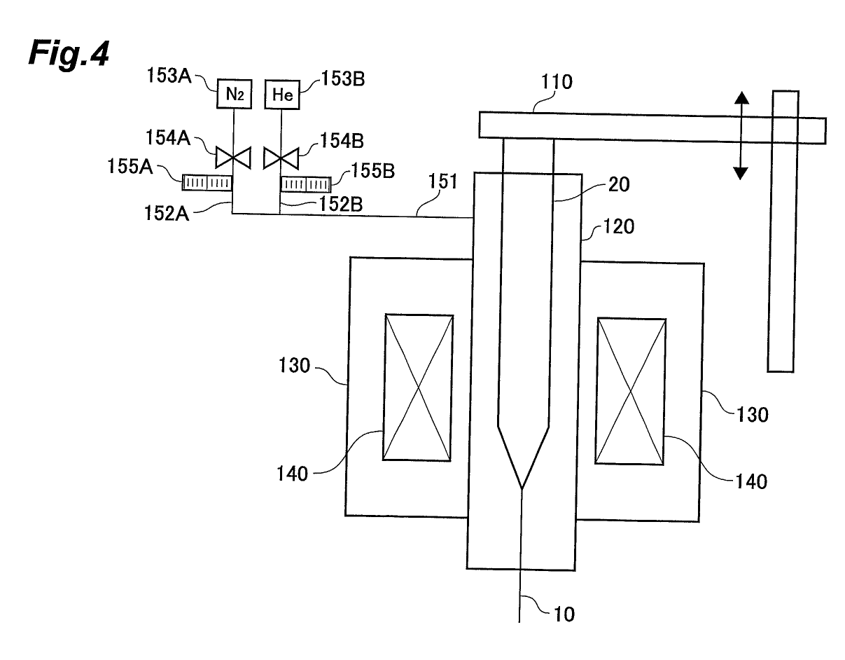

First, the first embodiment of the optical fibermaking method and the optical fiber making apparatus according to the invention will be described. FIG. 4 is an explanatory diagram showing an essential portion of the optical fiber making apparatus (draw furnace 130 and its associated components). This embodiment changes either or both of the flow and composition of an inert gas supplied to and around the lower end of the preform 20 of the optical fiber in the furnace core tube 120 to change the amount of heat received by the lower end of the preform 20.

The optical fiber making apparatus according to this embodiment has, as a means for supplying the inert gas to the interior of the furnace core tube 120, a main pipe 151 connected to the furnace core tube 120, two branch pipes 152A, 152B branching from the main pipe 151, a gas source 153A, a valve 154A and a flowmeter 155A connected to one branch pipe 152A, and a gas source 153B, a valve 154B and a flowmeter 155B connected to the other branch pipe 152B.

The gas sources 153A and 153B supply inert gases (N₂, He, Ar, etc.) of different compositions into the furnace core tube 120. The inert gas supplied from the gas source 153A is fed through the branch pipe 152A and the main pipe 151 into the furnace core tube 120. The flow of the inert gas supplied from the gas source 153A is adjusted by the valve 154A and measured by the flowmeter 155A. The inert gas supplied from the gas source 153B is fed through the branch pipe 152B and the main pipe 151 into the furnace core tube 120. The flow of the inert gas supplied from the gas source 153B is adjusted by the valve 154B and measured by the flowmeter 155B.

Based on the measurements by the flowmeters 155A and 155B of flows of each inert gas, the draw controller 300 controls the valves 154A and 154B to adjust the respective inert gas flows and thereby change the flows or compositions of the inert gases supplied from the gas sources 153A and 153B into the furnace core tube 120. This makes it possible to change the amount of heat received by the lower end of the preform 20, without depending solely on the main heater 140, to adjust the draw tension and thereby change the local chromatic dispersion along the longitudinal direction of the optical fiber 10 being manufactured.

It is preferred that the draw controller 300, based on the glass draw tension of the optical fiber 10 measured by the tension measuring device 220, changes the flow or composition of the inert gas supplied from the gas sources 153A and 153B into the furnace core tube 120 so that the measured tension will become a desired value. In this way, fine adjustments can be made of the flow or composition of the inert gas to produce a desired draw tension.

From the standpoint of making the optical fiber 10 with excellent transmission characteristic by shortening the transient sections between the positive dispersion sections 11 and the negative dispersion sections 12, it is desired that the flow and composition of the inert gas be changed in a short period of time. However, too sharp a change in the flow and composition of the inert gas causes variations in the temperature distribution and preform molten state in the furnace core tube 120, resulting in an increase in the deviation of the glass diameter of the optical fiber 10, making it impossible for the glass diameter control to follow the variation. This in turn gives rise to a danger of possible break of the optical fiber 10. Therefore, according to the flows of the inert gases measured by the flowmeters 155A, 155B, the draw controller 300 controls the valves 154A, 154B to adjust the flows of the inert gases in as short a time as the optical fiber glass diameter control can follow the deviation, thereby changing the flow or composition of the inert gasses supplied from the gas sources 153A, 153B into the furnace core tube 120.

The inventors of this invention conducted an experiment whereby an optical fiber 10 was drawn from the preform 20 about 35 mm in outer diameter installed in the furnace core tube 120 about 45 mm in inner diameter and 350 mm in length. The result of this experiment is described below. A He gas was used which has a high thermal conductivity and commonly used as the inert gas for the drawing, and the line speed was set at 100 m/min. The temperature of the main heater 140 and the feed speed of the feeder were set so that the draw tension would become 98 mN (10 g) for the flow of 20 L/min. In this condition, only the gas flow was changed to 40 L/min and the draw tension was found to be 147 mN (15 g). When an N₂ gas was used instead, with the temperature of the main heater 140 and the feeder speed left unchanged, the draw tension was 196 mN (20 g) for the flow of 20 L/min and 274 mN (28 g) for 40 L/min. Supplying a mixture of different inert gases into the furnace core tube 120 and changing the composition ratio and flows of the mixed gases also resulted in a change in the draw tension. In this way, a desired draw tension was able to be produced by adjusting the composition or flow of the inert gas. It is needless to say that the relation between the composition or flow of the inert gas and the draw tension varies depending on the shape and size of the draw furnace 130 and the furnace core tube 120.

Next, the above-described furnace core tube and the optical fiber preform were used and, without changing the heated state of the furnace core tube 120 by the main heater 140, the flow and composition of the inert gas supplied into the furnace core tube 120 were changed so that the absolute values of the local chromatic dispersions of the positive dispersion sections 11 and the negative dispersion sections 12 of the optical fiber 10 would be 1 ps/nm/km or more. The line speed was set at 300 m/min. That is, in the positive dispersion sections 11, the He gas flow was set at 10 L/min and the N₂ gas flow at 40 L/min. This resulted in the draw tension of 882 mN (90 g), which in turn produced the local chromatic dispersion of +4.5 ps/nm/km at a wavelength of 1.55 μm. In the negative dispersion sections 12, on the other hand, setting the He gas flow at 30 L/min and N₂ gas flow at 15 L/min produced the draw tension of 392 mN (40 g), thereby generating the local chromatic dispersion of −4.5 ps/nm/km at the wavelength of 1.55 μm.

In this manner, a dispersion-altered optical fiber 10 was manufactured which has a total length of 20 km with each section 2 km long. At the wavelength of 1.55 μm, the average chromatic dispersion over the entire length of the optical fiber 10 was 0.1 ps/nm/km and its transmission loss was 0.23 dB/km. Here, too, the relation between the composition or flow of the inert gas and the draw tension varies depending on the shape and size of the draw furnace 130 and the furnace core tube 120.

### (Second Embodiment)

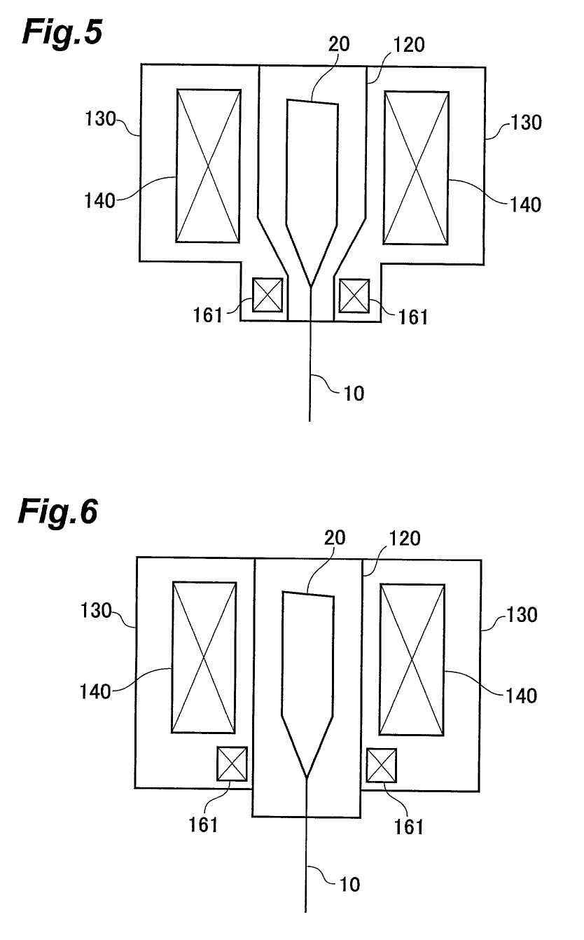

Next, the second embodiment of the optical fiber making method and the optical fiber making apparatus according to the present invention will be described. FIG. 5 is an explanatory view showing an essential portion (draw furnace 130 and its associated components) according to the second embodiment. In this embodiment, there is provided an auxiliary heater 161 in addition to the main heater 140. The amount of heat applied to the lower end of the preform 20 is changed by changing the heating condition of the auxiliary heater 161.

The optical fiber making apparatus according to this embodiment has the auxiliary heater 161 installed around the furnace core tube 120 below the main heater 140. The auxiliary heater 161 should preferably be installed near the lower end (narrowed neck portion) of the preform 20. As shown in the figure, the furnace core tube 120 is narrowed in diameter at its lower portion to match the shape of the preform 20 whose lower end is heated and melted. The auxiliary heater 161 is installed around the narrowed portion of the furnace core tube 120 so that it is close to the lower end of the preform 20. The temperature of the auxiliary heater 161 is measured by a radiation thermometer (not shown).

The auxiliary heater 161 has a capacity of approximately 5 kW. The draw controller 300 changes the heating state (on temperature-control or off) of the auxiliary heater 161. This can change the amount of heat received by the lower end of the preform 20 without depending solely on the main heater 140 and thereby adjust the draw tension to change the local chromatic dispersion along the longitudinal direction of the optical fiber 10 being manufactured.

The draw controller 300 suitably changes the heating condition of the auxiliary heater 161 according to the glass draw tension of the optical fiber 10 measured by the tension measuring device 220 so that the measured tension becomes a desired value. This can finely adjust the heating condition of the auxiliary heater 161 to produce a desired draw tension. To reduce the tension the auxiliary heater 161 is turned on. Turning off the auxiliary heater 161 can increase the tension.

The heating condition of the main heater 140 for the furnace core tube 120 was set, without being varied, to produce a draw tension such that the local chromatic dispersion in the positive dispersion sections 11 and the negative dispersion sections 12 of the optical fiber 10 would be 1 ps/nm/km or more in absolute value. In this condition, the auxiliary heater 161 was turned on (temperature control) or off. That is, in the positive dispersion sections 11, by turning off the auxiliary heater 161 the draw tension of 882 mN (90 g) was be obtained. This in turn made it possible to produce the local chromatic dispersion of +4.5 ps/nm/km at the wavelength of 1.55 μm. In this embodiment, the temperature of the auxiliary heater 161 was in the range of 900° C. to 1000° C. due to the heat conduction from the surroundings. In the negative dispersion sections 12, on the other hand, the auxiliary heater 161 was turned on (temperature was controlled at 1700° C.) to produce the draw tension of 392 mN (40 g), which in turn resulted in the local chromatic dispersion of −4.5 ps/nm/km at the wavelength of 1.55 μm. The auxiliary heater 161 was frequently turned on or off for temperature control to maintain a desired tension while measuring the tension by the tension measuring device. In this way, a dispersion-altered optical fiber 10 was manufactured which has a total length of 20 km with each section 2 km long. At the wavelength of 1.55 μm, the average chromatic dispersion over the entire length of the optical fiber 10 was 0.1 ps/nm/km and the transmission loss was 0.23 dB/km.

Although the furnace core tube 120 in FIG. 5 is shown tapered off toward its lower end, other shapes, such as shown in FIG. 6, can be used. The auxiliary heater 161 may be installed inside the housing of the draw furnace 130 as shown in FIGS. 5 and 6 or outside the housing.

### (Third Embodiment)

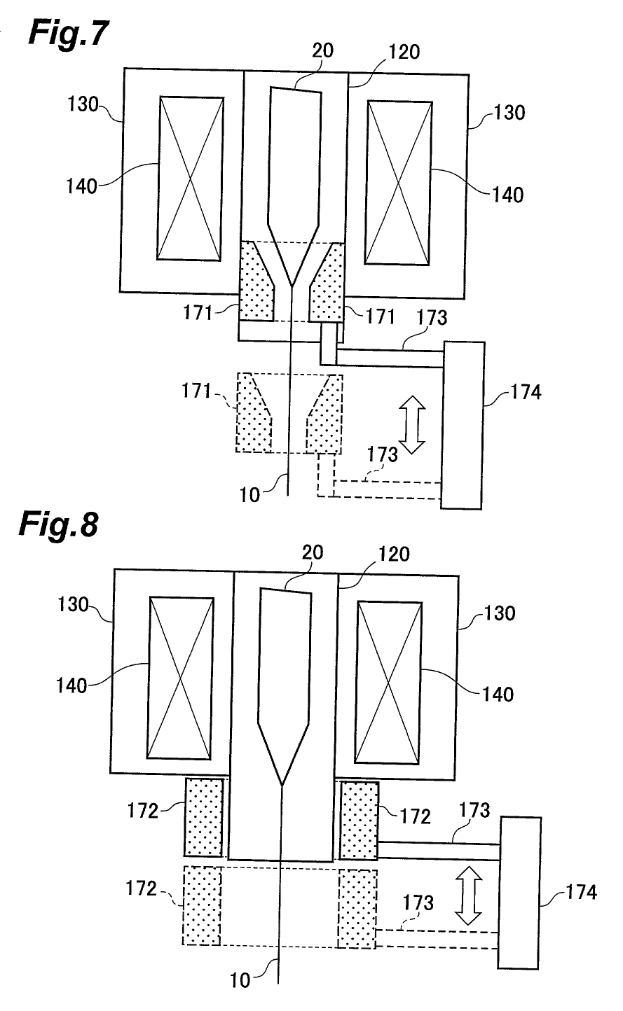

Next, the third embodiment of the optical fiber making method and the optical fiber making apparatus according to the invention will be described. FIG. 7 is an explanatory view showing an essential portion (draw furnace 130 and its associated components) of the optical fibermaking apparatus according to the third embodiment. This embodiment has an insulating material 171 arranged close to the lower end of the preform 20. The thermal insulating state is changed by the insulating material 171 to change the amount of heat applied to the lower end of the preform 20.

The optical fiber making apparatus of this embodiment has an insulating material 171 disposed close to the lower end of the preform 20, a support member 173 for supporting the insulating material 171, and a drive unit 174 for vertically moving the insulating material 171 through the support member 173. The insulating material 171 is shaped almost like a tube surrounding the lower part of the preform 20 and its inner side is tapered to conform to the shape of the lower part of the preform 20. The insulating material 171 can be moved vertically by the drive unit 174 to change the thermal insulating state and thereby change the amount of heat applied to the lower end portion of the preform 20. That is, when the insulating material 171 is moved up and rests between the lower portion of the preform 20 and the furnace core tube 120, the thermal insulating is most effective, insulating a part of radiant heat from the preform 20 to the furnace core tube 120. By moving up the insulating material 171, the temperature of the lower end of the preform 20 can be raised. When the insulating material 171 is moved down below the draw furnace 130, there is no thermal insulating effect. Moving the insulating material 171 downward can reduce the temperature of the lower end of the preform 20.

The draw controller 300 moves the insulating material 171 vertically through the drive unit 174 and the support member 173. This can change the amount of heat applied to the lower end of the preform 20, without depending solely on the main heater 140, to adjust the glass draw tension and thereby change the local chromatic dispersion along the longitudinal direction of the optical fiber 10 being manufactured.

Further, according to the glass draw tension of the optical fiber 10 measured by the tension measuring device 220, the draw controller 300 preferably changes the thermal insulating state by the insulating material 171, i.e., the position of the insulating material 171, so that the measured tension will become a desired value. This allows the position of the insulating material 171 to be finely adjusted to obtain a desired draw tension.

The heating condition of the main heater 140 for the furnace core tube 120 was set, without being varied, to produce a draw tension such that the local chromatic dispersion in the positive dispersion sections 11 and the negative dispersion sections 12 of the optical fiber 10 would be 1 ps/nm/km or more in absolute value. In this condition, the insulating material 171 was vertically moved. That is, in the positive dispersion sections 11, the insulating material 171 was set at the lowered position and the draw tension obtained was 882 mN (90 g). This in turn made it possible to produce the local chromatic dispersion of +4.5 ps/nm/km at the wavelength of 1.55 μm. In the negative dispersion sections 12, on the other hand, the insulating material 171 was set at the raised position and the draw tension of 392 mN (40 g) was obtained, which in turn resulted in the local chromatic dispersion of −4.5 ps/nm/km at the wavelength of 1.55 μm. In this way, a dispersion-altered optical fiber 10 was manufactured which has a total length of 20 km with each section 2 km long. At the wavelength of 1.55 μm, the average chromatic dispersion over the entire length of the optical fiber 10 was 0.1 ps/nm/km and the transmission loss was 0.23 dB/km.

The insulating material 171 may be arranged so that it can be inserted into the furnace core tube 120 as shown in FIG. 7, or an insulating material 172 may be movably provided around the furnace core tube 120 as shown in FIG. 8. In the latter case, the insulating material 172, when installed around the furnace core tube 120, prevents heat dissipation from the furnace core tube 120. The insulating material 172 is moved upward to raise the temperature of the lower end of the preform 20. When on the other hand the insulating material 172 is lowered below the furnace core tube 120, the heat dissipation from the furnace core tube 120 is encouraged. Moving the insulating material 172 downward from the raised position can lower the temperature of the lower end of the preform 20.

### (Fourth Embodiment)

Next, the fourth embodiment of the optical fiber making method and the optical fiber making apparatus according to the invention will be described by referring to FIG. 4. In this embodiment, the positional relation between the preform 20 and the furnace core tube 120 is changed to change the amount of heat received by the lower end of the preform 20 of optical fiber. That is, the preform 20 is vertically moved by the feeder 110.

When the lower end of the preform 20 is disposed somewhat lower than the center of the main heater 140 (located close to the lower end of the main heater), the temperature of the lower end of the preform 20 can be raised. When on the other hand the lower end of the preform 20 is moved up from that position, the temperature of the lower end of the preform 20 goes down. The draw controller 300 vertically moves the preform 20 by the feeder 110. This arrangement can change the amount of heat applied to the lower end of the preform 20, without depending solely on the main heater 140, to adjust the draw tension and thereby change the local chromatic dispersion along the longitudinal direction of the optical fiber 10 being fabricated.

The draw controller 300 preferably changes the position of the preform 20 according to the glass draw tension of the optical fiber 10 measured by the tension measuring device 220 so that the measured tension will become a desired value. In this manner, the position of the preform 20 can be finely adjusted to produce a desired draw tension.

The heating condition of the main heater 140 for the furnace core tube 120 is set, without being varied, to produce a draw tension such that the local chromatic dispersion in the positive dispersion sections 11 and the negative dispersion sections 12 of the optical fiber 10 will be 1 ps/nm/km or more in absolute value. In this condition, the preform 20 is moved up or down. That is, while the optical fiber is being drawn at the line speed of 300 m/min, the preform 20 is disposed at the lower position for the positive dispersion sections 11 so that the lower end of the preform 20 is somewhat below the center of the main heater 140, thus increasing the draw tension. This can render the local chromatic dispersion at the wavelength of 1.55 μm positive. In the negative dispersion sections 12, on the other hand, the preform 20 is disposed at the upper position (20 mm above the lower position) to reduce the draw tension. This can make the local chromatic dispersion at the wavelength of 1.55 μm negative. This is because moving the preform 20 up or down changes the line speed of the optical fiber 10 and therefore the tension. To keep the glass diameter of the optical fiber 10, the feed speed of the feeder 110 is controlled to ensure that the line speed of the optical fiber 10 will not change significantly.

The experiment conducted by the inventors of this invention found that the rate of change of the tension of the optical fiber 10 was approximately 19.6 mN (2 g)/min when the temperature of the draw furnace 130 was changed by the main heater 140, and that when the gas flow was changed, the rate of change of the tension of the optical fiber 10 was approximately 78.4 mN (8 g)/min. When the local chromatic dispersion is varied between +4.5 ps/nm/km and −4.5 ps/nm/km, i.e., the tension is varied between 882 mN (90 g) and 392 mN (40 g), the method of changing the temperature of the draw furnace 130 by the main heater 140 takes 25 minutes while the method of changing the gas flow takes only six minutes, realizing a significant time reduction.

As described above, this invention can change the temperature of the lower end of the optical fiber preform in the furnace core tube in a short time by changing the amount of heat received by the optical fiber preform without depending solely on the main heater. Thus, when the optical fiber to be manufactured is a dispersion-altered optical fiber, for example, the transient sections between the positive dispersion sections and the negative dispersion sections can be shortened, realizing the capability of suppressing waveform deterioration due to nonlinear optical phenomena.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical fiber making method comprising the steps of;
inserting an optical fiber preform into a furnace core tube of a draw furnace;
heating the furnace core tube with a main heater to heat and melt a lower end portion of the optical fiber preform; and
drawing an optical fiber from the lower end of the optical fiber preform;
wherein, while drawing the optical fiber, an amount of heat applied to the lower end portion of the optical fiber preform is changed, without depending solely on the main heater, to change a draw tension and thereby change a local chromatic dispersion along a longitudinal direction of the optical fiber being manufactured.

2. An optical fiber making method according to claim 1, wherein a gas is supplied to a periphery of the lower end portion of the optical fiber preform and at least one of gas flow rate and gas composition is changed to change the amount of heat applied to the lower end portion of the optical fiber preform.

3. An optical fiber making method according to claim 1, wherein an amount of heat supplied from an auxiliary heater provided close to the lower end portion of the optical fiber preform is changed to change the amount of heat applied to the lower end portion of the optical fiber preform.

4. An optical fiber making method according to claim 1, wherein a part of the heat dissipated from the furnace core tube or the lower end portion of the optical fiber preform is controlled and the dissipating condition is changed, so as to change the amount of heat applied to the lower end portion of the optical fiber preform.

5. An optical fiber making method according to claim 1, wherein a positional relation between the optical fiber preform and the furnace core tube are changed to change the amount of heat applied to the lower end portion of the optical fiber preform.

6. An optical fiber making method according to claim 1, wherein a draw tension is measured and the amount of heat applied to the lower end portion of the optical fiber preform is adjusted so that the measured draw tension will become a predetermined value.

7. An optical fiber making apparatus comprising:
a draw furnace having a furnace core tube into which an optical fiber preform is inserted and a main heater to heat the furnace core tube, the draw furnace heating and melting a lower end portion of the optical fiber preform;
a feeder to feed the optical fiber preform into the furnace core tube;
a draw means to draw an optical fiber from the lower end of the optical fiber preform in the draw furnace; and
a draw tension adjust means to adjust a draw tension by adjusting the amount of heat applied to the lower end portion of the optical fiber preform.

8. An optical fiber making apparatus according to claim 7, wherein the draw tension adjust means has a gas supply means for supplying a gas to a periphery of the lower end portion of the optical fiber preform, and the gas supply means varies either or both of flow and composition of the gas supplied.

9. An optical fiber making apparatus according to claim 7, wherein the draw tension adjust means has an auxiliary heater disposed close to the lower end portion of the optical fiber preform and controllable independently of the main heater.

10. An optical fiber making apparatus according to claim 7, wherein the draw tension adjust means has:
an insulating means disposed close to the lower end portion of the optical fiber preform to control heat dissipated from the furnace core tube or the lower end portion of the optical fiber preform; and
an insulating means varying device to change a position or state of the insulating means.

11. An optical fiber making apparatus according to claim 7, wherein a tension measuring means to measure an actually applied draw tension is provided and the draw tension adjust means controls the amount of heat applied to the lower end portion of the optical fiber preform so that the draw tension measured by the tension measuring means becomes a predetermined value.
